(19) United States
(12) Patent Application Publication
(10) Pub. No.: US 2024/0393447 A1
(43) Pub. Date: Nov. 28, 2024

(54) A UWB radar device

(71) Applicant: Aria Sensing S.r.l., Rezzato (BS) (IT)

(72) Inventor: Alessio Cacciatori, Rezzato (IT)

(21) Appl. No.: 18/689,002

(22) PCT Filed: Sep. 7, 2022
(86) PCT No.: PCT/IB2022/058398

§ 371 Date: Mar. 4, 2024

(30) Foreign Application Priority Data
Sep. 10, 2021 (IT) 102021000023444

(51) Int. Cl. G01S 13/02; G01S 7/28; G01S 7/282; G01S 7/285; G01S 13/44

(52) U.S. Cl. CPC G01S 13/0209; G01S 7/2806; G01S 7/282; G01S 7/285; G01S 13/4463; G01S 2013/0245

(57) ABSTRACT

A UWB radar device having two or more first antennas includes a generating and transmitting assembly of a UWB signal having a predetermined number of generating and transmitting circuits of a UWB signal, a receiving assembly for processing the received UWB signal, and a processing and control logic unit. The predetermined number of generating and transmitting circuits is lower than the number of the first antennas. The UWB radar device further includes a first selector connected with at least one of the generating and transmitting circuits of the signal and with at least two of the first antennas so as to convey the received signal to the first antennas. The processing and control logic unit includes a memory unit, in which a delay and sum algorithm executable by the logic unit is stored so as to manage the change of phase of the signals received in the receiving assembly.

### FIELD OF APPLICATION

The present invention is applicable to the telecommunications field and, in particular, relates to radars for receiving and transmitting signals in radio frequency.

In more detail, the present invention refers to a UWB radar device.

### BACKGROUND ART

In the field of telecommunications, the transmission technique called UWB, namely Ultra WideBand, is known, which has been developed to transmit and receive signals using pulses in radio frequency with extremely short duration and, therefore, with very wide spectral occupation. These pulses are represented by a few wave cycles of a radiofrequency carrier and therefore the frequency spectrum associated with this waveform is extremely large, that is it returns ambipolar pulses whose duration is so short that a carrier is not required.

The advantage of this technique lies in the fact that the shortness of the pulse makes signal transmission insensitive to the interferences due to the multiple reflections of the wave itself and, at the same time, particularly suitable for the measurement of the flight time of the radio signals.

The bandwidth means that the power spectral density is very low, limiting, among other things, the interferences towards the surrounding applications. This band, which can reach significant widths, is obtainable with extremely low electrical powers in the antenna.

For these characteristics this technique is also used in the field of the radars.

As is well known, a radar is a system that uses electromagnetic waves to detect and determine the position, and possibly the speed, of both fixed and mobile objects.

In particular, the operation of the radar is based on the physical phenomenon of the reflection of electromagnetic radiation when it hits an object whose dimensions are larger than the wavelength of the incident radiation.

An important characteristic is that the signal must have excellent directivity, i.e. radars must be characterized by antennas with the ability of radiating the signal according to a privileged direction. This characteristic of the radar devices is necessary in order to be able to distinguish objects, whether fixed or mobile, placed at the same distance from the radar. Furthermore, the signal directivity allows to direct most of the energy in the chosen direction, increasing the maximum detection distance.

Another relevant characteristic is that the signal must allow the highest possible resolution of the detection and have a reduced dispersion in the module and in the phase in order to ensure that the radiated signal is as much as possible coincident with that to power the antenna in order to increase the spatial resolution of the radar.

In particular, these aspects are very important in the case of radar detections of the 2D and/or 3D type, in which the peculiarities of the UWB radars require the use of beamforming techniques to perform effective detections.

Beamforming is a particular technology that makes it possible to direct and concentrate the transmitted signal (in this case a UWB signal) in one direction rather than in another and, in the case of the UWB radars, it requires the use of multiple antennas arranged in different positions so as to generate and transmit signals with different phases.

However, in the known architectures of the UWB radars for excited antennas to be obtained with different phases it is necessary to provide a plurality of transmitting and receiving circuits. This means, first of all, that the differences in the signal propagation times in the different circuits reduce the accuracy of the “cross-range” resolution (i.e. the detection of the angle of arrival of the signal of the target).

In addition, the need to provide a considerable number of circuits, both for transmission and reception, requires a very large area of silicon. Moreover, their use necessarily entails a very high energy consumption for their operation.

In addition thereto, document US 2012/229322 A1 is known which describes an apparatus and a method for the remote detection and monitoring of objects that uses triangulation and signal overlap. However, this calculation methodology is not very functional for the UWB devices because the reduced dimensions and especially the proximity of the antennas do not allow to obtain signals with a good resolution.

Documents US 2021/139045 A1 and EP 2 315 311 A1 are also known which respectively describe a radar guidance system for motor vehicles and a radar system but which, nevertheless, do not solve the drawbacks described above.

### PRESENTATION OF THE INVENTION

The object of the present invention is to provide a UWB radar device that allows to overcome at least partially the drawbacks highlighted above.

In particular, the object of the present invention is to provide a radar of the UWB type suitable for use for 2D and/or 3D detections.

Another object of the present invention is to provide a UWB radar capable of performing beamforming techniques effectively in order to improve detection compared to equivalent radars present in the prior art.

A further object of the present invention is to provide a UWB radar that allows to lower the energy consumption required for its operation.

Another object of the present invention is to provide a UWB radar whose components occupy a limited area of silicon, or in any case smaller than the equivalent devices present in the prior art.

A further object of the present invention is to provide a UWB radar device capable of limiting the differences in signal propagation times(phase) in the receiving and/or transmitting circuits so as to improve the detection of the angle of arrival of the signal of the target.

Said objects, as well as others that will appear more clearly below, are achieved by a UWB radar device having two or more first antennas in accordance with the following claims which are to be considered an integral part of this patent.

In particular, it comprises a generating and transmitting assembly of a UWB signal, in turn comprising a predetermined number of generating and transmitting circuits, and a receiving assembly for processing the received UWB signal.

According to another aspect of the invention, the radar device also comprises at least one processing and control logic unit operatively located downstream of the aforesaid receiving assembly.

According to a further aspect of the invention, the predetermined number of the generating and transmitting circuits of the signal is lower than the number of the first antennas.

Thus, the radar device of the invention advantageously comprises a reduced number of generating and transmitting circuits that is smaller than the number of equivalent circuits present in the known radars where, typically, each transmission antenna corresponds to a circuit.

Still advantageously, since the number of circuits of the device of the invention is lower than the known equivalent radars, it allows optimizing the use of silicon occupying an area that is smaller than the equivalent devices present in the prior art.

Furthermore, still advantageously, the UWB radar device of the invention, having a lower number of generating and transmitting circuits of the signal allows to lower the energy consumption required for its operation compared to the known equivalent radars.

According to another aspect of the invention, the UWB radar device also comprises a first selector operatively connected with at least one of the generating and transmitting circuits of the signal and with at least two of the first antennas so as to convey the signal generated by the generating and transmitting circuit mutually to the at least two first antennas.

Furthermore, according to a further aspect of the invention, the processing and control logic unit comprises at least one memory unit in which at least one delay and sum algorithm suitable for being executed by the processing and control logic unit is stored so as to manage the change of phase of the signals received in the receiving channels.

Advantageously, the use of the same generating and transmitting circuit of the UWB signal for multiple antennas, together with the use of the delay and sum algorithm, makes it possible to limit the differences in the phase of the signal in the receiving circuits in order to improve the accuracy of the “cross-range” resolution, i.e. the detection of the angle of arrival of the signal of the target.

On closer inspection, the UWB radar device of the invention is suitable for performing beamforming techniques to improve the directioning and the concentration of the transmitted signal and, consequently, to improve the detection compared to equivalent radars present in the prior art.

According to what has been said, it is therefore evident that the radar device of the invention is, still advantageously, suitable for being used also for 2D and/or 3D type detections.

### BRIEF DESCRIPTION OF THE DRAWINGS

Further characteristics and advantages of the invention will become more apparent in the light of the detailed description of some preferred, but not exclusive, embodiments of a UWB radar device according to the invention, illustrated by way of non-limiting example with the aid of the accompanying drawing tables in which:

FIG. 1 represents the UWB radar device according to the invention in a schematic view;

FIG. 2 represents a comparison between a known periodic signal and a periodic signal sent by the radar device of FIG. 1;

FIG. 3 represents a known UWB radar device in a schematic view.

### DETAILED DESCRIPTION OF AN EXEMPLARY PREFERRED EMBODIMENT

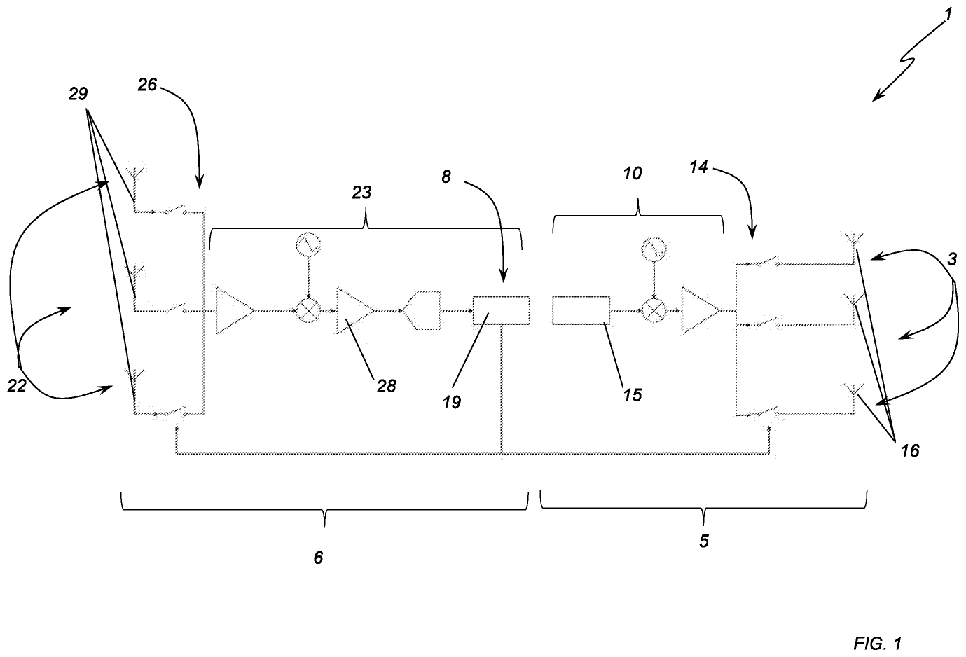

With reference to the aforesaid figures and, in particular to FIG. 1, a UWB radar device 1 having first antennas 3 according to the invention is described. Obviously, the number of first antennas should not be considered limiting for different embodiments of the invention.

According to one aspect of the invention it comprises a generating and transmitting assembly of a UWB signal 5, a receiving assembly of a UWB signal 6, for processing the received signal, and a processing and control logic unit 8 operatively located downstream of said receiving assembly 6.

According to another aspect of the invention, the generating assembly 5 comprises a predetermined number of generating and transmitting circuits 10 of a UWB signal.

In particular, the predetermined number of generating circuits 10 is lower than the number of the first antennas 3 included in the radar device 1. This advantageously makes it possible to occupy a smaller surface area of silicon than the equivalent UWB radar devices present in the prior art where, generally, each first antenna corresponds to a generating and transmitting circuit, as can be seen in FIG. 3.

According to a further aspect of the invention, the radar device 1 also comprises a first selector 14 operatively connected with a generating and transmitting circuit 15 and with two first antennas 16 so as to convey the signal generated by the circuit 15 mutually on the two first antennas 16.

In other words, the UWB radar device 1 comprises a first selector 14 suitable for connecting the generating and transmitting circuits 10 with more than one first antenna 3.

Advantageously, this makes it possible to send the UWB signals generated by the same generating and transmitting circuit 15 by means of more first antennas 3 so as to eliminate, or at least limit, the differences of phase that inevitably arise from the generation of signals on different circuits.

Obviously, also the number of the first antennas to which each generating and transmitting circuit is operatively connected should not be considered as limiting for different embodiments of the invention.

According to another aspect of the invention, the processing and control logic unit 8 comprises a memory unit 19 in which a delay and sum algorithm is stored, i.e. an algorithm of the DAS (Delay And Sum) type, suitable for being executed by the logic unit 8 itself, so as to manage the change of phase of the signals received in the receiving assembly 6.

In fact, since the antennas 3 are very close, in the device 1 of the invention it is not possible to perform the triangulation of the signals, moreover, the proximity of the antennas 3 makes it extremely difficult, if not impossible, to perform the sampling that would be necessary for the pursuit of this technique.

Thus, the DAS-type algorithm stored in the logic unit 8 performs a Fourier transform, typically but not necessarily a fast Fourier transform (FFT), to modify the signal passing from the time domain to the frequency domain, so as to be able to act on the signal spectra.

Subsequently, knowing the flight times of the signals, the latter are shifted by a factor as a function of the flight time itself. In other words, the various signals emitted by the device 1 are rephased. Thus, the algorithm advantageously allows to overcome the problem deriving from the close arrangement of the antennas.

Consequently, again by means of the aforesaid algorithm it is possible to perform the inverse of the Fourier transform and thus add the signals to identify any targets.

Advantageously, by means of the aforesaid algorithm, the logic unit 18 rephases the signal in such a way as to maximize the difference of the signals themselves and, consequently, so as to obtain the reception of the target despite the reduced dimensions and the proximity of the antennas 3 typical of the UWB radar devices 1.

In fact, in the device 1 of the invention the signals being received are added by rephasing them as a function of the flight time of the signal. Therefore, still advantageously, the signals in the field of the frequencies are added without having to resort to the overlap.

Advantageously, by means of this logarithm and using the same generating and transmitting circuit 15 to send the signal by means of more first antennas 16, the radar device 1 allows to improve the accuracy of the “cross-range” resolution, i.e. to optimize the detection of the angle of arrival of the signal of the target.

Furthermore, still advantageously, the UWB radar device 1 is particularly suitable for use for 2D and/or 3D type detections.

Still advantageously, it makes it possible to perform beamforming techniques to improve the directioning and the concentration of the transmitted signal and, consequently, to improve the detection compared to the equivalent radars present in the prior art.

On closer inspection, therefore, the UWB radar device 1 of the invention has a lower cost than the equivalent radars present in the prior art, as it is necessary, as said, a smaller silicon area, consumes a lower power given the use of a single generating and transmitting circuit 15, allows to have a higher spatial resolution and can also be used for 2D or 3D type detections.

However, compared to the state of the art, the device of the invention has a reduced scanning speed as the cycle time for sending each signal is large, since for more than one first antennas the signal is generated by a single generating circuit.

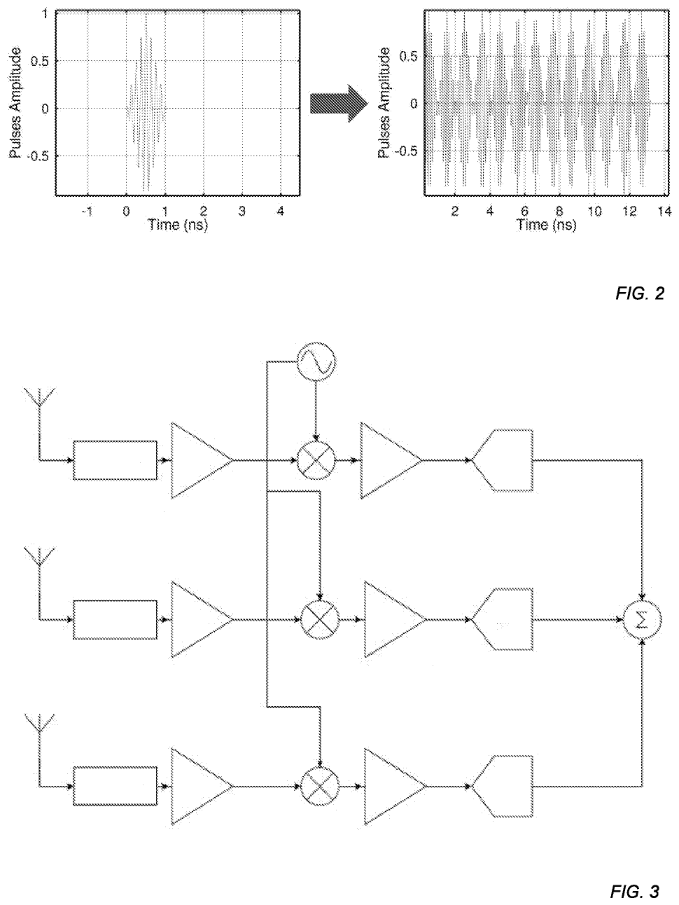

According to a further aspect of the invention, the generating and transmitting circuit 15, differently from the prior art that can be observed in the graph to the left of FIG. 2, generates and transmits periodic signals in which each signal comprises a plurality of pulses in the single period (pulse compression), as in the graph to the right of the same FIG. 2.

Advantageously, this technique of sending more pulses for a single period allows to increase the total energy radiated during a single reading and, still advantageously, it allows to take advantage of fewer consecutive readings (coherent integration) than the known equivalent devices.

In this way, still advantageously, by means of the UWB radar device 1 it is possible to compensate for the cycle time obtaining maximum reading speeds comparable to the state of the art.

Moreover, according to another aspect of the invention, the generated and transmitted pulses are encoded so as to increase the power of the overall UWB signal at the same amplitude of the single pulse.

Thus, still advantageously, the generation of more pulses allows to improve the signal-to-noise ratio, often abbreviated with the English acronym SNR (Signal to Noise Ratio), at the same peak power.

Still advantageously, this allows to improve the scanning speed compared to the equivalent UWB radar devices present in the prior art.

According to a further aspect of the invention, the radar device 1 also comprises more than one second antenna 22. Furthermore, the receiving assembly 6 comprises in turn a predetermined number of receiving circuits of a UWB signal 23, which is lower than the number of the second antennas 22.

Similar to what is described for the generating assembly 5, also in the receiving assembly there are a limited number of receiving circuits 23 with respect to the number of second antennas 22 and, therefore, also in this case there is a smaller area of silicon occupied with respect to the known equivalent devices.

According to another aspect of the invention, the radar device 1 also comprises a second selector 26 operatively connected with a receiving circuit of the signal 28 and with at least one pair of second antennas 29 so as to convey the signal received mutually from the latter to the receiving circuit 28.

In addition, according to an embodiment variant of the invention, not represented in the figures, the receiving assembly comprises a predetermined number of receiving circuits of a UWB signal that is lower than the number of first antennas.

Moreover, again according to this embodiment variant, the UWB radar device also comprises a second selector operatively connected with the receiving circuit of the signal and the first antennas so as to convey the signal received mutually to the receiving circuit of the signal.

In other words, according to this embodiment variant, the first antennas are conformed so as to both act in transmission and in reception of the UWB signals.

In particular, according to the embodiment of the invention that is being described, the predetermined number of generating and transmitting circuits of the UWB signal is equal to one.

Similarly, again according to the embodiment of the invention that is being described, the predetermined number of receiving circuits of the UWB signal is also equal to one.

Advantageously, this allows to minimize as much as possible the occupied area of silicon and, consequently, to reduce the production costs of the UWB radar devices compared to the known equivalent radars.

In light of the foregoing, it is therefore understood that the UWB radar device of the invention achieves all the set purposes.

In particular, it allows to use a smaller area of silicon and, therefore, allows to reduce the production costs compared to equivalent radars present in the prior art.

Furthermore, the radar device of the invention also makes it possible to lower the power consumption required for its operation compared to known radars.

In addition, the UWB radar device of the invention makes it possible to limit the differences in the signal propagation times in the receiving circuits so as to improve the detection of the angle of arrival of the signal of the target.

Finally, the device of the invention is capable of performing beamforming techniques effectively so as to improve the detection compared to equivalent radars present in the known art and, consequently, is particularly suitable for use for 2D and/or 3D detections.

The invention is susceptible to numerous modifications and variations, all falling within the appended claims. Moreover, all the details and steps may furthermore be replaced by other technically equivalent elements, and the materials may be different depending on needs, without departing from the protection scope of the invention defined by the appended claims.

1. A UWB radar device having two or more first antennas (3) and comprising:
a generating and transmitting assembly (5) of a UWB signal comprising a predetermined number of generating and transmitting circuits (10) of a UWB signal;
a receiving assembly (6) of the UWB signal for processing the received UWB signal; and
at least one processing and control logic unit (8) operatively located downstream of said receiving assembly (6);
wherein:
said predetermined number of said generating and transmitting circuits (10) of the UWB signal is lower than a number of said two or more first antennas (3);
said UWB radar device (1) comprises a first selector (14) operatively connected with at least one generating and transmitting circuit (15) of said generating and transmitting circuits (10) of the UWB signal and with at least two of said two or more first antennas (16) so as to convey the UWB signal generated by said at least one generating and transmitting circuit (15) of said generating and transmitting circuits (10) of the UWB signal mutually to said at least two of said two or more first antennas (16); and
said at least one processing and control logic unit (8) comprises at least one memory unit (18), in which at least one delay and sum algorithm configured for being executed by said at least one processing and control logic unit (8) is stored so as to manage a change of phase of the UWB signals received in said receiving assembly (6).

2. The UWB radar device according to claim 1, wherein said at least one generating and transmitting circuit (15) generates and transmits periodic signals, and wherein each period comprises a plurality of pulses.

3. The UWB radar device according to claim 1, further comprising two or more second antennas (22), wherein said one receiving assembly (6) comprises a predetermined number of receiving circuits (23) of said UWB signal, said predetermined number of said receiving circuits (23) of said UWB signal is lower than a number of said two or more second antennas (22).

4. The UWB radar device according to claim 3, further comprising at least a second selector (26) operatively connected with at least one receiving circuit (28) of said receiving circuits (23) of the UWB signal and with at least two antennas (29) of said two or more second antennas (22) so as to convey the UWB signal received mutually from said at least two antennas (29) of said second two or more antennas (22) to said at least one receiving circuit (28) of said receiving circuits (22) of the signal.

5. The UWB radar device according to claim 3, wherein said one receiving assembly comprises a predetermined number of receiving circuits of the UWB signal, said predetermined number of said receiving circuits of the UWB signal being lower than the number of said two or more first antennas.

6. The UWB radar device according to claim 5, further comprising at least one second selector operatively connected with at least one of said receiving circuits of the UWB signal and with at least two of said two or more first antennas so as to convey the UWB signal received mutually from said at least two of said two or more second antennas to said at least one of said receiving circuits of the UWB signal.

7. The UWB radar device according to claim 2, wherein said pulses are encoded so as to increase a power of the UWB signal at a same amplitude as a single pulse.

8. The UWB radar device according to claim 1, wherein said predetermined number of generating and transmitting circuits (10) of the UWB signal is equal to one.

9. The UWB radar device according to claim 3, wherein said predetermined number of receiving circuits (23) of the UWB signal is equal to one.
